(19) United States
(12) Patent Application Publication
(10) Pub. No.: US 2024/0127089 A1
(43) Pub. Date: Apr. 18, 2024

(54) INFERENCE DEVICE, INFERENCE METHOD, AND RECORDING MEDIUM

(71) Applicant: NEC Corporation, Minato-ku, Tokyo (JP)

(72) Inventors: Takuya KAWADA, Tokyo (JP); Kazeto YAMAMOTO, Tokyo (JP); Daichi KIMURA, Tokyo (JP)

(73) Assignee: NEC Corporation, Minato-ku, Tokyo (JP)

(21) Appl. No.: 18/278,101

(22) PCT Filed: Feb. 25, 2021
(86) PCT No.: PCT/JP2021/007027

§ 371 Date: Aug. 21, 2023

(51) Int. Cl. G06N 5/04

(52) U.S. Cl. CPC G06N 5/041

(57) ABSTRACT

In an inference device, an observation input means receives an observation as an input. A hypothesis candidate generation means generates hypothesis candidates by applying inference knowledge to the observation in the backward direction. The problem conversion means converts the hypothesis candidate into an ILP problem or a SAT problem. An equivalent problem generation means generates a specified number of equivalent ILP problems or equivalent SAT problems in which an order of the variables included in the converted ILP problem or SAT problem is changed. The solver parallelization means solves the generated equivalent ILP problems or equivalent SAT problems by executing a specified number of identical ILP solvers or SAT solvers in parallel. The optimal solution output means outputs a result of the ILP solver or the SAT solver that output the result first, among the specified number of ILP solvers or SAT solvers, as the optimal solution.

### TECHNICAL FIELD

The present invention relates to a technique of abductive reasoning.

### BACKGROUND ART

Abductive reasoning is a technique to derive a reasonable hypothesis from inferential knowledge (rules) given by logical expressions, and observed events. For example, in the field of cyber security, abductive reasoning can be applied to determine whether an observed event in a computer system is due to a cyber attack. Patent Document 1 describes a technique to quickly determine the best hypothesis in abductive reasoning by converting generated hypothesis candidates into an ILP (Integer Linear Programming Problem) or a SAT (Satisfiability Problem).

### PRECEDING TECHNICAL REFERENCES

### Patent Document

Patent Document 1: International Publication WO2020/003585

### Non-Patent Document

Non-Patent Document 1: Naoya Inoue and Kentaro Inui, ILP-based Reasoning for Weighted Abduction. In Proceedings of AAAI Workshop on Plan, Activity and Intent Recognition, pp. 25-32, August 2011.

### SUMMARY

### Problem to be Solved

However, when hypothesis candidates are converted to an ILP problem or a SAT problem and inputted to an ILP solver or a SAT solver to obtain an optimal solution, there is such a problem that the time required to obtain the solution greatly varies, even if the problems inputted to the ILP solver or the SAT solver have similar sizes. Also, when solving the ILP problem or the SAT problem using the ILP solver or the SAT solver, basically it is not possible to predict how long it takes to obtain the solution. For this reason, for a given ILP or SAT problem, the solver does not always output the optimal solution in the shortest time. In the worst case, the solver may output the optimal solution in the longest time required to obtain the optimal solution.

It is one object of the present invention to speed up abductive reasoning by solving an ILP problem or a SAT problem obtained by converting hypothesis candidates in the shortest possible time.

### Means for Solving the Problem

According to an example aspect of the present invention, there is provided an inference device comprising:
an observation input means configured to receive an observation as an input;
a hypothesis candidate generation means configured to generate hypothesis candidates by applying inference knowledge to the observation in a backward direction;
a problem conversion means configured to convert the hypothesis candidates to an ILP problem or a SAT problem;
an equivalent problem generation means configured to generate a specified number of equivalent ILP problems or equivalent SAT problems in which an order of variables included in the converted ILP problem or the converted SAT problem is changed;
a solver parallelization means configured to solve the equivalent ILP problems or the equivalent SAT problems by executing the specified number of identical ILP solvers or SAT solvers in parallel; and
an optimal solution output means configured to output a result of the ILP solver or the SAT solver that outputs the result first, among the ILP solvers or the SAT solvers of the specified number, as an optimal solution.

According to another example aspect of the present invention, there is provided an inference method comprising:
receiving an observation as an input;
generating hypothesis candidates by applying inference knowledge to the observation in a backward direction;
converting the hypothesis candidates to an ILP problem or a SAT problem;
generating a specified number of equivalent ILP problems or equivalent SAT problems in which an order of variables included in the converted ILP problem or the converted SAT problem is changed;
solving the equivalent ILP problems or the equivalent SAT problems by executing the specified number of identical ILP solvers or SAT solvers in parallel; and
outputting a result of the ILP solver or the SAT solver that outputs the result first, among the ILP solvers or the SAT solvers of the specified number, as an optimal solution.

According to still another example aspect of the present invention, there is provided a recording medium recording a program, the program causing a computer to execute:
receiving an observation as an input;
generating hypothesis candidates by applying inference knowledge to the observation in a backward direction;
converting the hypothesis candidates to an ILP problem or a SAT problem;
generating a specified number of equivalent ILP problems or equivalent SAT problems in which an order of variables included in the converted ILP problem or the converted SAT problem is changed;
solving the equivalent ILP problems or the equivalent SAT problems by executing the specified number of identical ILP solvers or SAT solvers in parallel; and
outputting a result of the ILP solver or the SAT solver that outputs the result first, among the ILP solvers or the SAT solvers of the specified number, as an optimal solution.

### Effect of the Invention

According to the present invention, it is possible to speed up abductive reasoning by solving an ILP problem or a SAT problem obtained by converting hypothesis candidates in the shortest possible time.

### BRIEF DESCRIPTION OF THE DRAWINGS

FIGS. 1A to ID are diagrams for explaining weighted abductive reasoning.

FIG. 2 shows a hardware configuration of an inference device according to a first example embodiment.

FIG. 3 shows a functional configuration of the inference device according to the first example embodiment.

FIG. 4 is a flowchart of an inference processing by the inference device of the first example embodiment.

FIG. 5A to 5C shows an example of applying the technique of the example embodiment to certain abductive reasoning.

FIGS. 6A and 6B are examples of generating and converting a SAT problem.

FIG. 7 shows a functional configuration of an inference device according to a second example embodiment.

FIG. 8 is a flowchart of an inference processing by the inference device of the second example embodiment.

FIG. 9 shows a configuration of an action plan estimation device to which the inference device of the example embodiments is applied.

FIG. 10 is a flowchart showing an operation of the action plan estimation device.

FIG. 11 shows an example of operation logs and context information acquired in step A1 of FIG. 10.

FIG. 12 shows an example of a group created in step A2 of FIG. 10.

FIG. 13 shows an example of an action plan estimated by abductive reasoning in step A3 of FIG. 10.

FIG. 14 shows a display example of an action plan and a message in step A6 of FIG. 10.

### EXAMPLE EMBODIMENTS

Preferred example embodiments of the present invention will be described with reference to the accompanying drawings.

### <Explanation of Principle>

### (Abductive Reasoning)

Abductive reasoning or abductive inference is a technique to derive a reasonable hypothesis from inference knowledge (rules) given by logical expressions, and observed events (obtained facts) (hereinafter simply referred to as “observations”). For example, when there is a rule that “B is established if A is established” (A⇒B), and we can observe that “B is established,” the abductive reasoning is a method of reasoning that “A is established, presumably because A is established,” and hypothesizing that “A is established.” Abductive reasoning is also called “backward reasoning” because it looks at the rule backward.

The inputs in abductive reasoning are observations and inferential knowledge (rules). Observations are conjunctions of first-order logical literals, and given as “animal(John)∧bark(John)”, for example. The parts of “animal” and “bark” are called predicates. “John” corresponds to the term in the predicate. Here, when a term begins with a capital letter, it indicates that the term is a constant, and the term represents an individual object that exists in the world to be expressed. When a term begins with a small letter, it indicates that the term is a variable. The term indicates the object that exists in the world to be expressed, but it is used when it is not determined what the term specifically corresponds to. The parts of “animal(John)” and “bark(John)” combining a predicate and a term are called literals. The inference knowledge (rule) is expressed as implication relation between literals or conjunctions of literals. For example, the rule “dog(x)⇒=animal(x)” indicates that “if x is a dog, x is an animal.” On the other hand, the output in abductive reasoning is the best explanation among multiple hypothesis candidates, and it is called “solution hypothesis” or “best hypothesis”. Incidentally, in the logical symbols, the term “∧” is called conjunction, and represents a logical AND operation. “∨” is called disjunction, and represents a logical sum operation.

“¬” represents negative and “⇒” represents implication.

(Weighted Abductive Reasoning)

Weighted abductive reasoning is one of the methods of abductive reasoning, and generates hypothesis candidates by applying backward reasoning operation and unification operation. In weighted abductive reasoning, the smaller the sum of the overall costs, the better the explanation.

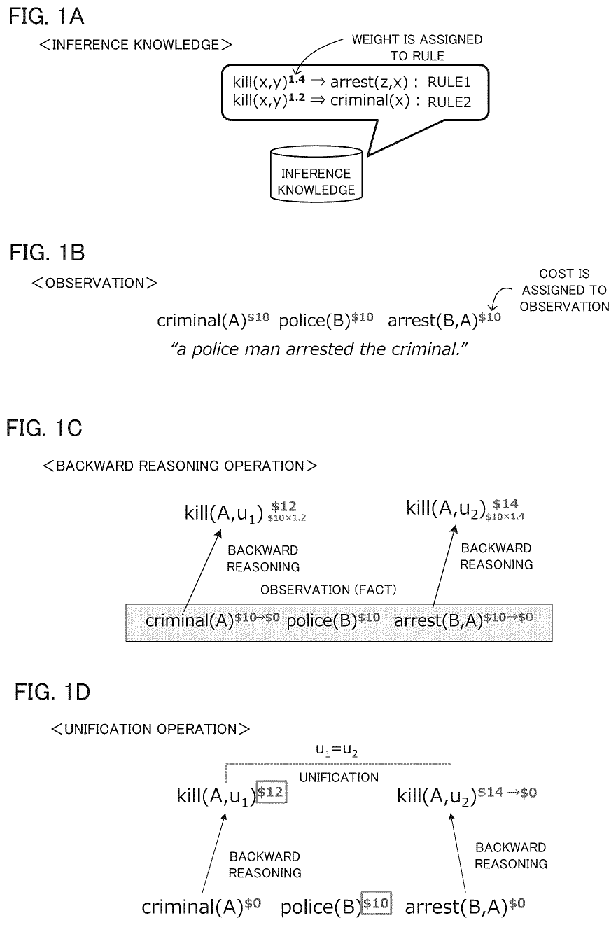

FIG. 1A shows an example of inference knowledge (rules) used for weighted abductive reasoning. Rule 1 “kill(x,y)^{1.4}⇒arrest(z,x)” indicates that “if x kills y, z will arrest x”. The literal located on the left side of the implications is called “antecedent”. In the above example, “kill(x,y)¹⁴” corresponds to the antecedent. The literal located on the right side of the implication is called “consequent”. In the example above, “arrest(z,x)” corresponds to the consequent. The value “1.4” assigned to the antecedent literal is the weight assigned to the literal. If multiple literals are concatenated by conjunctions in the antecedent, the sum of the weights assigned to each literal is the weight of the entire antecedent. The weight indicates the degree of confidence in the rule when hypothesizing the antecedent from the consequent. The greater the weight value, the less likely the antecedent is hypothesized from the consequent. Similarly, Rule 2 “kill(x,y)^{1.2}⇒criminal(x)” indicates that “if x kills y, x is a criminal”.

FIG. 1B shows an example of observation. If there is a fact that “a policeman (A) arrested a criminal (B)”, observations containing the following three literals can be obtained.
“criminal(A)^{$10}∧police(B)^{$10}∧arrest(B,A)^{$10}”
   Here, “$10” included in each observation is the cost, and the cost represents how much that literal should be explained.

FIG. 1C shows an example of backward reasoning operation using the above inferential knowledge and observations. First, we apply Rule 2 backwards to the observation literal “criminal(A)^{$10}”. In this case, since the cost of the inference are all propagated to the hypothesis, the cost of observation literal “criminal(A)” becomes “$0”, and the cost of the hypothesis “kill(A,u₁)” becomes “$12” as the product of the cost “$10” and the weight “1.2”. Thus, the hypothesis “kill(A,u₁)^{$12}” is obtained. Similarly, by applying Rule 1 backwards to the observation literal “arrest(B,A)^{$10}”, a hypothesis “kill(A,u₂)^{$14}” is obtained.

FIG. 1D shows an example of a unification operation. A unification operation hypothesizes that literal pairs with the same predicates are identical to each other. In FIG. 1D, it is hypothesized that the two literals “kill(A,u₁)^{$12}” and “kill(A,u₂)^{$14}” obtained by the backward reasoning operation shown in FIG. 1C are the same, that is, u₁=u₂. Since the literal having higher cost is canceled in the unification operation, “kill(A,u₁)^{$12}” remains. Therefore, the cost of the hypothesis candidate obtained in the unification operation is $10+$12=$22, which is the lowest. In other words, as a result of abductive reasoning of the fact that “the policeman (B) arrested the criminal (A)” based on the inference knowledge shown in FIG. 1A, the following is derived as a likely hypothesis (with lowest cost).
(1) A killed a person.
(2) B arrested A because A killed the person.

In this way, in weighted abductive reasoning, the best hypothesis is determined by generating a set of hypothesis candidates including a plurality of hypothesis candidates by performing a backward reasoning operation and a unification operation using inferential knowledge and observations, converting the obtained set of hypothesis candidates into an ILP problem or a SAT problem (hereinafter referred to as “ILP/SAT problem”) and obtaining an optimal solution using an ILP solver or a SAT solver (hereinafter, referred to as “ILP/SAT solver”).

Although weighted abductive reasoning has been described above as an example of abductive reasoning, the present example embodiment is applicable to abductive reasoning based on any evaluation function other than this.

(Inference Time by Solver)

As mentioned above, when a set of hypothesis candidates is converted into an ILP/SAT problem and solved by an ILP/SAT solver, the inference time may greatly varies depending on the case, even if the sizes of the problems inputted to the ILP/SAT solver is comparable. Specifically, even if the configuration of the inputs (the variables and the number of constraints in the ILP/SAT problem) to the ILP/SAT solver is the same, if the order of inputting the variables and the constraints to the ILP/SAT solver is different, the time required to obtain the solution greatly varies in the respective trials, although the same solution can be obtained. Furthermore, in general, it is not possible to predict the input order of variables that makes the inference time shortest in advance. For this reason, depending on the order of inputting the variables of the ILP/SAT problem to the ILP/SAT solver, the inference time to obtain the solution may become the longest time by that ILP/SAT solver.

Therefore, in the following example embodiments, when a set of hypothesis candidates is converted to an ILP/SAT problem, the set of hypothesis candidates is converted to a plurality (n) of ILP/SAT problems (hereinafter also referred to as “equivalent ILP/SAT problems”) in which the configuration of the ILP/SAT problem (the numbers of variables and constraints) is the same, but the order of the variables in the ILP/SAT problem, i.e., the order of inputting the variables to the ILP/SAT solver is different. Then, a plurality (n) of identical ILP/SAT solvers are prepared to solve n ILP/SAT problems in parallel, and the solution obtained first from those n ILP/SAT solvers is outputted as an optimal solution.

A plurality of equivalent ILP/SAT problems have the same numbers of variables and constraints, but the orders of inputting the variables to the ILP/SAT solver are different. When the equivalent ILP/SAT problems are solved in parallel using the plurality of identical ILP/SAT solvers, it is ensured that the ILP/SAT solvers output identical solutions, although the times required to output the solutions are different. Therefore, the equivalent ILP/SAT problems are solved in parallel using the several identical ILP/SAT solvers, and the solution obtained earliest is adopted as the optimal solution. This makes it possible to speed up abductive reasoning as much as possible.

### First Example Embodiment

[Hardware Configuration]

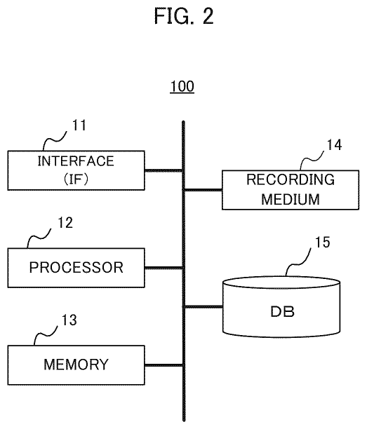

FIG. 2 is a block diagram illustrating a hardware configuration of the inference device 100 according to the first example embodiment. The inference device 100 includes an interface (IF) 11, a processor 12, a memory 13, a recording medium 14, and a data base (DB) 15.

The IF 11 inputs and outputs data to and from external devices. Specifically, observations and inference knowledge used for inference are inputted through the IF 11. Also, the inference result by the inference device 100 is outputted to the external device through the IF 11.

The processor 12 is a computer such as a CPU (Central Processing Unit) or a GPU (Graphics Processing Unit) and controls the entire inference device 100 by executing a program prepared in advance. The processor 12 may be a FPGA (Field-Programmable Gate Array). Specifically, the processor 12 performs the inference processing described later.

The memory 13 may include a ROM (Read Only Memory) and a RAM (Random Access Memory). The memory 13 stores observation, inference knowledge, hypothesis candidates generated in the inference processing of the present example embodiment, and the like. The memory 13 is also used as a working memory during various processes performed by the processor 12.

The recording medium 14 is a non-volatile and non-transitory recording medium such as a disk-like recording medium or a semiconductor memory, and is configured to be detachable from the inference device 100. The recording medium 14 records various programs executed by the processor 12. When the inference device 100 performs various processes, the program recorded in the recording medium 14 is loaded into the memory 13 and executed by the processor 12. The database 15 stores the inference knowledge entered through the IF 11 as a knowledge base. The inference knowledge may be stored, not in the database 15, but in the memory 13.

[Functional Configuration]

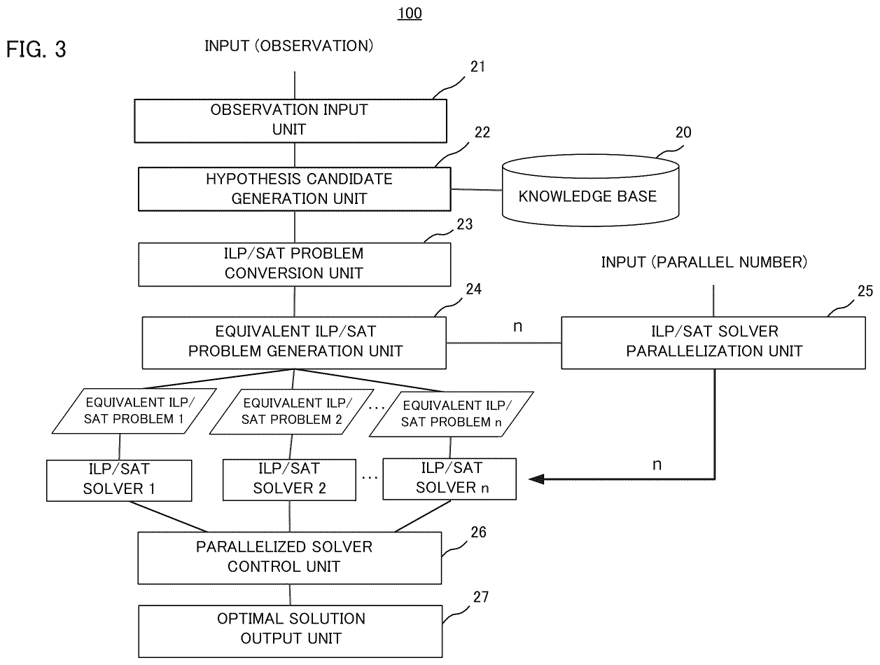

FIG. 3 is a block diagram showing a functional configuration of the inference device 100 according to the first example embodiment. The inference device 100 includes a knowledge base 20, an observation input unit 21, a hypothesis candidate generation unit 22, an ILP/SAT problem conversion unit 23, an equivalent ILP/SAT problem generation unit 24, an ILP/SAT solver parallelization unit 25, a parallelized solver control unit 26, and an optimal solution output unit 27.

The knowledge base 20 stores inference knowledge (rules) used for abductive reasoning. The observation input unit 21 receives an observation that is an observed event as an input, and outputs it to the hypothesis candidate generation unit 22. Note that the observation is inputted as observation logical expressions that express the observed event in terms of logical expressions.

The hypothesis candidate generation unit 22 generates hypothesis candidates by applying the inference knowledge stored in the knowledge base 20 backward to the inputted observation. For example, when using the above-described weighted abductive reasoning, the hypothesis candidate generation unit 22 generates a plurality of hypothesis candidates by applying a backward reasoning operation and a unification operation to the observation. The hypothesis candidate generation unit 22 outputs the generated hypothesis candidates to the ILP/SAT problem conversion unit 23 as a set of hypothesis candidates.

The ILP/SAT problem conversion unit 23 converts the inputted set of hypothesis candidates into an ILP problem or a SAT problem, and generates an ILP/SAT problem including variables and constraints. The ILP/SAT problem is a problem to be solved by the ILP/SAT solvers. The generated ILP/SAT problem is outputted to the equivalent ILP/SAT problem generation unit 24.

The ILP/SAT solver parallelization unit 25 receives a parallel number n inputted by the user. The parallel number n is the number of the ILP/SAT solvers used in parallel, and is also the number of the equivalent ILP/SAT problems generated by the equivalent ILP/SAT problem generation unit 24. The ILP/SAT solver parallelization unit 25 outputs the inputted parallel number n to the equivalent ILP/SAT problem generation unit 24. The parallel number is an example of a specified number.

The equivalent ILP/SAT problem generation unit 24 generates the equivalent ILP/SAT problems of the parallel number n from the inputted ILP/SAT problem. The equivalent ILP/SAT problem is a problem that is logically equivalent to the inputted ILP/SAT problem, but the order of the variables included in the inputted ILP/SAT problem has been randomly changed. Here, the order of the variables is the order of inputting the variables to the ILP/SAT solver when solving the problem using the ILP/SAT solver. Therefore, for example, when the inputted ILP/SAT problem includes X variables, the equivalent ILP/SAT problem generation unit 24 randomly changes the input order of the X variables to generate n equivalent ILP/SAT problems 1 to n.

On the other hand, the ILP/SAT solver parallelization unit 25 activates n identical ILP/SAT solvers 1 to n based on the parallel number n to solve the equivalent ILP/SAT problems 1 to n generated by the equivalent ILP/SAT problem generation unit 24. Specifically, the ILP/SAT solver parallelization unit 25 assigns the equivalent ILP/SAT problem 1 to the ILP/SAT solver 1 and assigns the equivalent ILP/SAT problem 2 to the ILP/SAT solver 2. In this way, the ILP/SAT solver parallelization unit 25 assigns the equivalent ILP/SAT problems 1 to n to the ILP/SAT solvers 1 to n, respectively, to solve the equivalent ILP/SAT problems 1 to n. Each of the ILP/SAT solvers finds the solution of the corresponding ILP/SAT problem and outputs the solution to the parallelized solver control unit 26.

Here, the time required for each of the ILP/SAT solvers 1 to n to generate the solution (hereinafter referred to as “answer time”) are different. Although n ILP/SAT solvers 1 to n are identical solvers, the input order of the variables in the equivalent ILP/SAT problems 1 to n to the ILP/SAT solvers are randomly changed as described above. Therefore, the answer times of the ILP/SAT solvers are different due to the input order of the variables. However, since the equivalent ILP/SAT problems are solved using the same ILP/SAT solvers, it is ensured that the solutions outputted by the respective ILP/SAT solvers are the same.

The parallelized solver control unit 26 adopts the solution of the ILP/SAT solver that outputs the solution first, i.e., fastest, from among the ILP/SAT solvers 1 to n, as the optimal solution, and outputs the solution to the optimal solution output unit 27. Thus, the solution can be obtained in the shortest time among the solution times of n ILP/SAT solvers. The parallelized solver control unit 26 may terminate the operation of other ILP/SAT solvers at the time when it acquires the solution from the fastest ILP/SAT solver. Thus, the computational resources of the terminated ILP/SAT solvers can be used for other processes, and the computational resources can be effectively utilized.

The optimal solution output unit 27 restores the best hypothesis in the set of hypothesis candidates from the optimal solution inputted from the parallelized solver control unit 26 and outputs the best hypothesis.

[Inference Processing]

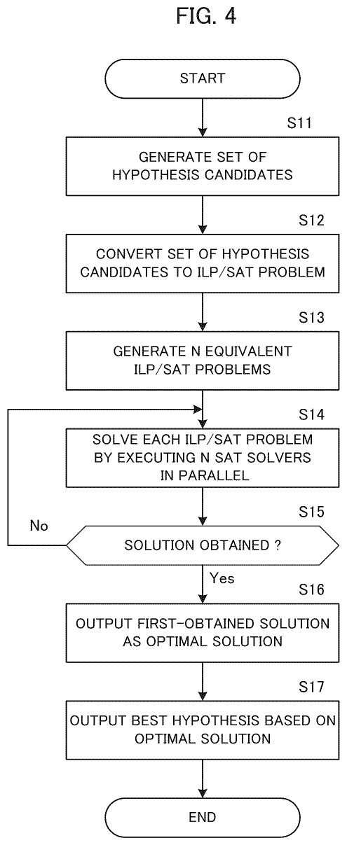

FIG. 4 is a flowchart of inference processing performed by the inference device 100 according to the first example embodiment. This processing is realized by the processor 12 shown in FIG. 2, which executes a program prepared in advance and operates as each element shown in FIG. 3. As a premise of the processing, it is assumed that the parallel number n has been inputted by the user into the ILP/SAT solver parallelization unit 25.

First, the observation input unit 21 receives the input of the observation, and the hypothesis candidate generation unit 22 generates a set of hypothesis candidates using the inference knowledge in the knowledge base 20 (step S11). Next, the ILP/SAT problem conversion unit 23 converts the set of hypothesis candidates to an ILP/SAT problem (step S12). Next, the equivalent ILP/SAT problem generation unit 24 generates n equivalent ILP/SAT problems from the inputted ILP/SAT problem based on the parallel number n received from the ILP/SAT solver parallelization unit 25 (step S13).

Next, the ILP/SAT solver parallelization unit 25 activates n ILP/SAT solvers based on the parallel number n and makes them operate in parallel to solve the n equivalent ILP/SAT problems generated in step S13 (step S14). Next, the parallelized solver control unit 26 determines whether or not a solution is obtained from any one of the ILP/SAT solvers (step S15), and outputs the solution obtained first from one of the ILP/SAT solvers to the optimal solution output unit 27 as the optimal solution (step S16).

Then, the optimal solution output unit 27 determines and outputs the best hypothesis in the set of hypothesis candidates based on the optimal solution (step S17). Thus, the best hypothesis is determined from a plurality of hypothesis candidates included in the set of hypothesis candidates generated in step S11. The parallelized solver control unit 26 may terminate the operation of the other ILP/SAT solvers after outputting the first obtained solution to the optimal solution output unit 27 as the optimal solution.

### Examples

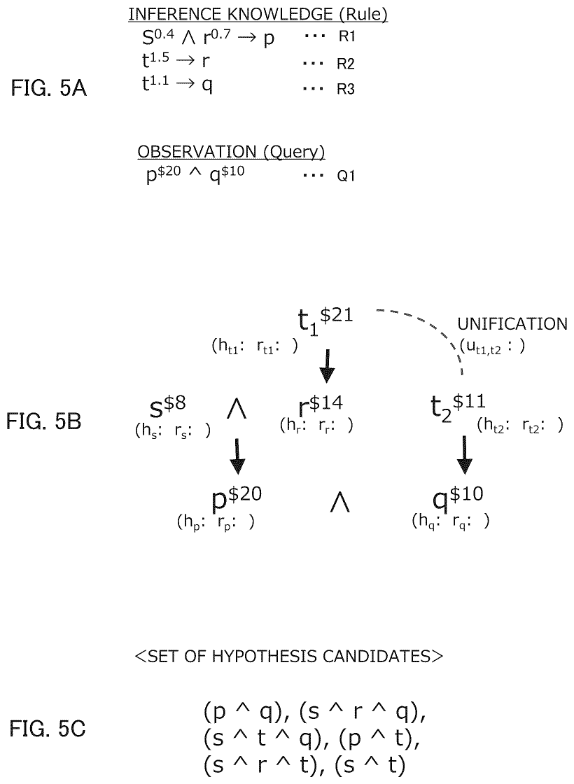

Next, an example in which the technique of the present example embodiment is applied to certain abductive reasoning will be described. In the following example, it is assumed that abductive reasoning is converted to a SAT problem. FIG. 5A shows the inferential knowledge (rule) R1 to R3 and the observation (query) Q1 used in this example. The numerical values in the inference knowledge, such as “0.4” in “s^{0.4}” in the inference knowledge R1, are weights. The numerical values in the observation, such as the “20” in the “p^{$20}” in the observation Q1, are costs.

First, the hypothesis candidate generation unit 22 applies the inference knowledge R1 to R3 to the observation Q1 backward to generate the hypothesis candidates. FIG. 5B shows the procedure for generating hypothesis candidates. When the inference knowledge R1 is applied backward to the literal “p^{$20}” of the observation Q1, “s^{$8}∧r^{$14}” is obtained. When the inference knowledge R2 is applied backward to the literal “r^{$14}” of the obtained “s^{$8}∧r¹⁴”, the literal “t₁^{$21}” is obtained. When the inference knowledge R3 is applied backward to the literal “q^{$10}” of the observation Q1, the literal “t₂^{$11}” is obtained. Here, the literals “t₁^{$21}” and “t₂^{$11}” can be unified.

As the hypothesis candidates, in addition to the (p∧q) corresponding to the original observation Q1, the following are obtained as hypothesis candidates: (s∧r∧q), (s∧t∧q), (p∧t), (s∧r∧t), and (s∧t). The set of hypothesis candidates is formed by these six hypothesis candidates.

Next, the following logical variables are introduced for each hypothesis candidate included in the set of hypothesis candidates. Note that x and y are arbitrary literals in the set of hypothesis candidates.
hₓ: True if the literal x is included in the hypothesis
rₓ: True if the literal x does not pay the cost
u_{x,y}: True if literal x is unified with the literal y

Thus, for each of the literals shown in FIG. 5B, the logical variables shown in the bracket below the literal are assigned. For example, logical variables (hₚ: rₚ:) are assigned to the literal “p^{$20}”.

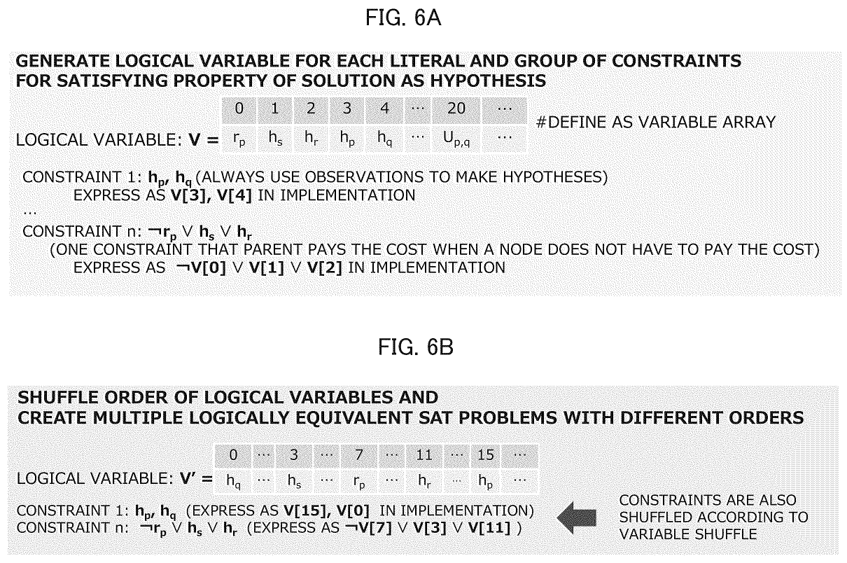

Next, the ILP/SAT problem conversion unit 23 converts the above-described set of hypothesis candidates to a SAT problem. FIG. 6A shows a sample conversion to the SAT problem. In the conversion to the SAT problem, a logical variable V is created by defining a logical variable for each literal as a variable array. Here, the logical variable V includes the logic variables assigned to each of the literals shown in FIG. 5B. The order in this logical variable V is the order of inputting the variables to the SAT solver.

Also, a group of constraints (SAT constraint formulas) to satisfy the property of the solution as a hypothesis is created. In the example of FIG. 6A, the constraints 1 to n are created. For example, constraint 1 is:
Constraint 1: hₚ, h_{q} (Observation must be used to make a hypothesis)
   This constraint 1 is expressed as the logical variables V[3] and V[4] on implementation. The constraint n is:
Constraint n: ¬rₚ∨hₛ∨hᵣ (one constraint that parent pays the cost when a node does not have to pay the cost)
   This constraint n is expressed as ¬V[0]∨V[1]∨V[2] on implementation. In this way, as a SAT problem, a variable array defining the logical variables assigned to the literals included in the set of hypothesis candidates and a group of constraints are created.

Next, the equivalent ILP/SAT problem generation unit 24 converts the generated SAT problem to equivalent SAT problems. FIG. 6B shows a sample conversion to equivalent SAT problems. The equivalent ILP/SAT problem generation unit 24 shuffles the order of the logical variables in the variable array and creates the equivalent SAT problems logically equivalent but the orders of the logical variables thereof are different. In the example of FIG. 6B, the order of the logic variables included in the logic variable V shown in FIG. 6A is shuffled to generate the logical variable V′. Due to the change of the order of the logical variables, the order of the logical variables in the variable array included in the constraints 1 to n changes. Therefore, the logical variables defining constraints 1 to n also changes.

Thus, the equivalent ILP/SAT problem generation unit 24 generates the equivalent SAT problems of a number equal to the parallel number n. By solving the generated n equivalent SAT problems by the SAT solvers, the solutions are outputted and the solution first outputted by one of the plurality of SAT solvers is adopted as the optimal solution.

Note that a method for converting a set of hypothesis candidates to an ILP problem is described in Non-Patent Document 1, for example. Also, a method for converting a set of hypothesis candidates into a SAT problem is described in Patent Document 1, for example, and Patent Document 1 is incorporated herein by reference.

[Modification]

In the above-described example embodiment, the equivalent ILP/SAT problem generation unit 24 generates a plurality of equivalent ILP/SAT problems by changing the order of inputting the logical variables included in the ILP/SAT problem. Here, the variables include the logical variables included in the set of hypothesis candidates and the logical variables included in the constraints as described above. That is, in the above-mentioned example, the logical variables included in the set of hypothesis candidates and the logical variables included in the constraints are collected, and the order of inputting them to the solver is changed to generate the equivalent ILP/SAT problems. Alternatively, only the orders of inputting the logical variables included in the set of hypothesis candidates may be changed to generate the equivalent ILP/SAT problems.

Since the ILP/SAT problem is defined by the logical variables and the group of constraints, the equivalent ILP/SAT problems may be generated by changing not only the order of inputting the variables but also the order of inputting a plurality of constraints to the ILP/SAT solver. In this case, the logical variables included in the constraint can be inputted to the ILP/SAT solver according to the changed input order of the constraints.

[Effect of Present Example Embodiment]

An experiment is performed in a certain abductive reasoning using Open-wbo as a SAT solver. When SAT solver is not parallelized, the inference time is about 18000 seconds. In contrast, when the method of this example embodiment was used and the SAT solver was parallelized with the parallel number 8 or more, the inference times were reduced to about 1000 seconds on average.

In the technique of this example embodiment, by increasing the parallel number n as long as the execution environment allows, the time required for abductive reasoning is likely to be shortened. However, even when the parallel number n is increased, the inference time is limited by the shortest solution time that the corresponding ILP/SAT solver can solve the same ILP/SAT problem.

In the technique of this example embodiment, the equivalent ILP/SAT problem is logically equivalent to the original ILP/SAT problem, although the order of the variables is changed. Therefore, the ILP/SAT solver requiring a long solution time and the ILP/SAT solver requiring a short solution time will output the same solution. For this reason, the accuracy of the inference result is not lowered by adopting the first output solution.

In this example embodiment, the parallelization of the solver allows efficient use of vacant computational resources in a multi-core environment recently common. In addition, since the reduction of inference time can be expected, it is possible to suppress the total consumption of memories, CPU, and the like.

### Second Example Embodiment

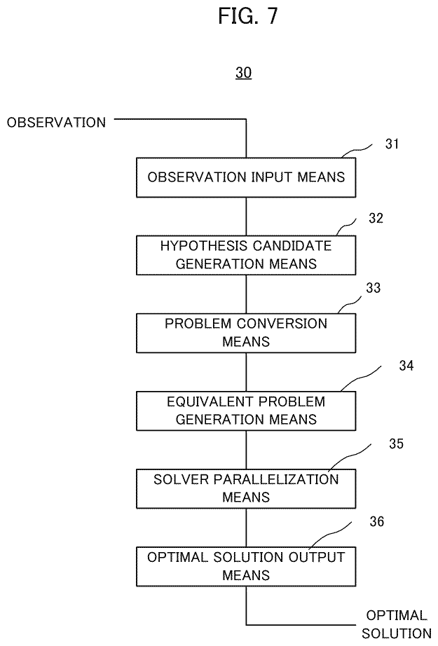

Next, a second example embodiment of the present invention will be described. FIG. 7 is a block diagram showing a functional configuration of an inference device 30 according to the second example embodiment. The inference device 30 includes an observation input means 31, a hypothesis candidate generation means 32, a problem conversion means 33, an equivalent problem generation means 34, a solver parallelization means 35, and an optimal solution output means 36.

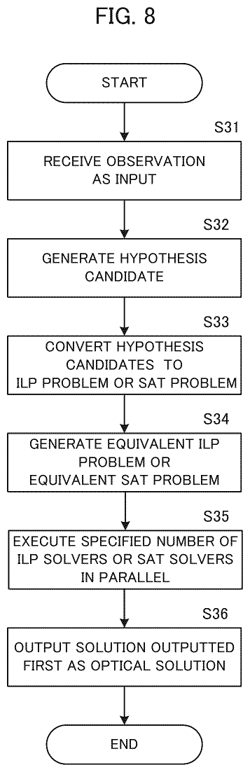

FIG. 8 is a flowchart of inference processing performed by the inference device 30 according to the second example embodiment. The observation input means 31 receives an observation as an input (step S31). The hypothesis candidate generation means 32 generates hypothesis candidates by applying inference knowledge to the observation in a backward direction (step S32). The problem conversion means 33 converts the hypothesis candidates to an ILP problem or a SAT problem (step S33). The equivalent problem generation means 34 generates a specified number of equivalent ILP problems or equivalent SAT problems in which an order of variables included in the converted ILP problem or the converted SAT problem is changed (step S34). The solver parallelization means 35 solves the equivalent ILP problems or the equivalent SAT problems by executing the specified number of identical ILP solvers or SAT solvers in parallel (step S35). The optimal solution output means 36 outputs a result of the ILP solver or the SAT solver that outputs the result first, among the ILP solvers or the SAT solvers of the specified number, as an optimal solution (step S36).

According to the inference device 30 of the second example embodiment, since the solution outputted earliest from the plurality of ILP/SAT solvers is outputted as the optimal solution, it is possible to speed up the abductive reasoning as much as possible.

### Implementation Example

Next, a description will be given of an implementation example of the inference device described above. In the following implementation example, the inference device of the above example embodiment is applied to an action plan estimation device.

[Device Configuration]

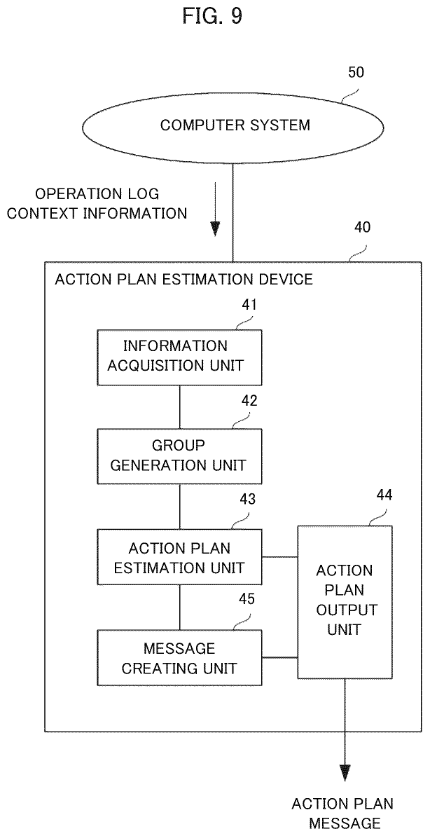

FIG. 9 is a block diagram showing a concrete configuration of an action plan estimation device 40 to which the inference device of the present example embodiment is applied. As shown in FIG. 9, the action plan estimation device 40 is connected to a computer system 50. The computer system 50 is constructed by a number of computers connected via a network. The action plan estimation device 40 estimates an action plan performed by software operating on the computer system 50, particularly software such as malware which attacks the computer system 50. The action plan estimation device 40 includes an information acquisition unit 41, a group generation unit 42, an action plan estimation unit 43, an action plan output unit 44, and a message creating unit 45. In this implementation example, the above-described first or second example embodiment is applied to the action plan estimation unit 43.

The information acquisition unit 41 first collects the operation logs from the computer system 50 and acquires the context information associated with the collected operation log. The context information is information including, for example, an execution time (start time), an execution location, an action entity, an action object or the like of the operation.

When one of the execution time (start time), the execution location, the action entity and the action object of the operation, included in each of a plurality of context information matches, for example, the group generation unit 42 determines that these operation logs are related, and classifies them in the same group.

As for the execution time, for example, it is determined that the execution times match when the difference between the execution times in the context information of two operation logs is equal to or smaller than the threshold value (within one hour, within one week, or the like). As for the execution location, it is determined that the execution locations match when the area in which each operation log was acquired is the same (on the same host machine, on the same domain network, within the transmission range, etc.). As for the execution location, it is determined that the execution locations match when the spatial distance or the distance in the network between the locations where the operations are performed is equal to or smaller than the threshold value (for example, when the acquisition source of the operation log is in the same section or a cooperation section).

In addition, as for the action entity, it is determined that the action entities match when the user accounts to which each of two operation logs is associated are matched, and when the privilege levels of the user accounts are equivalent. Further, as for the action entity, it is determined that the action entities match when each software that performs an action is the same malware, and when each software that performs an action is a series of malware or the like that has a track record of being used for the same attack. Further, as for the action object, it is determined that the action objects match when the objects targeted in each of two operation logs are the same or the objects of the same family.

The action plan estimation unit 43, to which the inference method of the first or second example embodiment described above is applied, first performs abductive reasoning by applying knowledge data to the operation log included in each group for each group. In this case, the knowledge data is represented by implication rules of first-order predicate logical expression.

The knowledge data is expressed, for example, in the form of “Prior state (Prerequisite)∧Action (achievement state) Posterior state (Consequence)”. In this form, if the prior state which is prerequisite and the action (achievement state) are both true, the posterior state which is inevitable consequence will be derived. Also, in this form, the prior state and action are the necessary conditions for the posterior state to hold. In addition, “Prior state∧Action” is a sufficient condition for the posterior state to hold. The action can also be expressed in conjunctions of multiple propositions. For example, the knowledge data may be expressed as “Prior state∧Action 1∧Action 2⇒Posterior state”.

A specific example of the knowledge data is: “Malware intrusion (Event1, Mal)∧Illegal Logon (Event2, Host, Host1)⇒Infection Expansion (Plan, Mal, Host1)”. In this case, “Event1”, “Mal”, “Host” are variables called “terms” of the predicates. Logical expressions that contain concrete values in the terms are called “Observation”. An example is “Illegal Logon (“e1”, “10.23.123.1”)”.

Specifically, when the inference device 100 of the first example embodiment is applied to the action plan estimation unit 43, the hypothesis candidate generation unit 22 generates the set of hypothesis candidates by applying the knowledge data to the operation logs included in the respective groups, and the ILP/SAT problem conversion unit 23 converts the generated set of hypothesis candidates into the ILP/SAT problem. The equivalent ILP/SAT problem generation unit 24 generates a plurality of equivalent ILP/SAT problems for the respective ILP/SAT problems. Then, the ILP/SAT solver parallelization unit 25 solves the plurality of equivalent ILP/SAT problems in parallel by operating a plurality of ILP solvers or SAT solvers, and outputs the first-obtained solution as an optimal solution. Then, the action plan estimation unit 43 outputs the best hypothesis based on the optimal solution as the inference result.

In addition, when the inference device 30 of the second example embodiment is applied to the action plan estimation unit 43, the hypothesis candidate generation unit 32 generates the set of hypothesis candidates by applying the knowledge data to the operation logs included in the respective groups, and the problem conversion unit 33 converts the generated set of hypothesis candidates into an ILP problem or a SAT problem. The equivalent problem generation means 34 generates a plurality of equivalent ILP problems or equivalent SAT problems for the converted ILP problem or SAT problem. The solver parallelization unit 35 operates a plurality of ILP solvers or SAT solvers to solve the plurality of equivalent ILP problems or equivalent SAT problems in parallel, and outputs the first-obtained solution as an optimal solution. Then, the action plan estimation unit 43 outputs the best hypothesis based on the optimal solution as the inference result.

Subsequently, as described above, the action plan estimation unit 43 estimates the action plan that is executed by the software in which the action log is acquired, from the action indicated by the action log included in each group to the preset target state, using the result of the abductive reasoning. Specifically, the action plan estimation unit 43 estimates the action to be performed by the software from the time when the action indicated by the operation log is performed to the time when the target state is reached, by using the result of the inference. Here, the “target state” includes, for example, a state in which the confidential information is transmitted to the outside, a state in which the requested amount of money is transmitted, and the like.

From the results of the hypothesis reasoning, the message creating unit 45 identifies the action necessary to establish the element not directly connected to the operation log. The message creating unit 45 uses the context information of the operation log to estimate the context information indicating the state of the identified operation, and generates a message about the action plan using the estimated context information.

The action plan output unit 44 outputs the estimated action plan to an external device such as a display device or a terminal device, for example. Thus, the action plan is displayed on the screen of the display device or the terminal device. When the message is generated by the message creating unit 45, the action plan output unit 44 may output the generated message to the external device in addition to the estimated action plan.

[Device Operation]

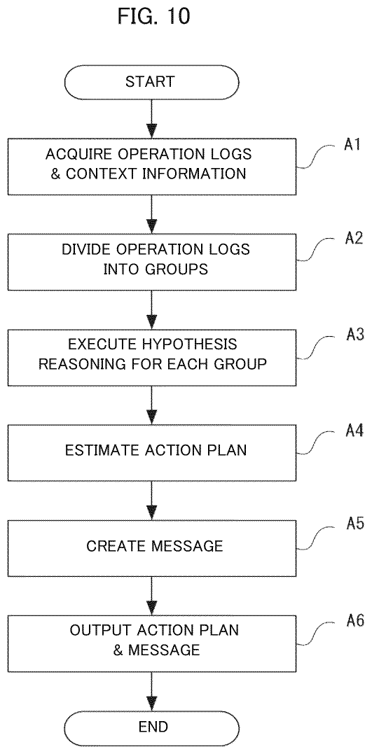

Next, the operation of the action plan estimation device 40 will be described with reference to FIG. 10. FIG. 10 is a flowchart illustrating the operation of the action plan estimation device. First, the information acquisition unit 41 acquires, for each operation performed by the software on the computer system 50, the operation log indicating the operation and the context information (step A1). Specifically, the information acquisition unit 41 collects the operation logs from the computer system 50 and acquires the context information associated therewith from the collected operation logs.

Next, the group generation unit 42 divides each of the operation logs acquired in step A1 into groups based on the similarity between the context information (step A2). Specifically, the group generation unit 42 determines that the operation logs are related if any one of the execution time (start time), the execution location, the action entity, and the action object of the operation included in each of the plurality of context information matches, and puts them into the same group.

Next, the action plan estimation unit 43 performs abductive reasoning by applying the knowledge data to the operation logs included in the groups for each group (step A3). At this time, the action plan estimation unit 43 converts each hypothesis candidate into an ILP problem or a SAT problem, generates a plurality of equivalent ILP problems or equivalent SAT problems from the converted ILP problem or the converted SAT problem, and solves those problems in parallel using a plurality of ILP solvers or SAT solvers, as described above. Then, the action plan estimation unit 43 determines the solution first obtained by the plurality of ILP solvers or SAT solvers as the optimal solution, and outputs the best hypothesis as the inference result based on the optimal solution.

Next, the action plan estimation unit 43 uses the result of the abductive reasoning in step A3 to estimate the action plan executed by the software in which the action logs are acquired, from the action indicated by the action log included in each group to a preset target condition (step A4).

Next, the message creating unit 45 generates a message about the action plan estimated in step A4 (step A5). Specifically, from the results of the abductive reasoning, the message creating unit 45 identifies the operations necessary for establishing the elements which are not directly connected to the operation log. The message creating unit 45 uses the context information of the operation log to estimate the context information indicating the state of the identified operation, and generates a message about the action plan using the estimated context information.

Next, the action plan output unit 44 outputs the action plan estimated in step A4 and the message generated in step A5 to an external device such as a display device or a terminal device (step A6).

### Specific Example

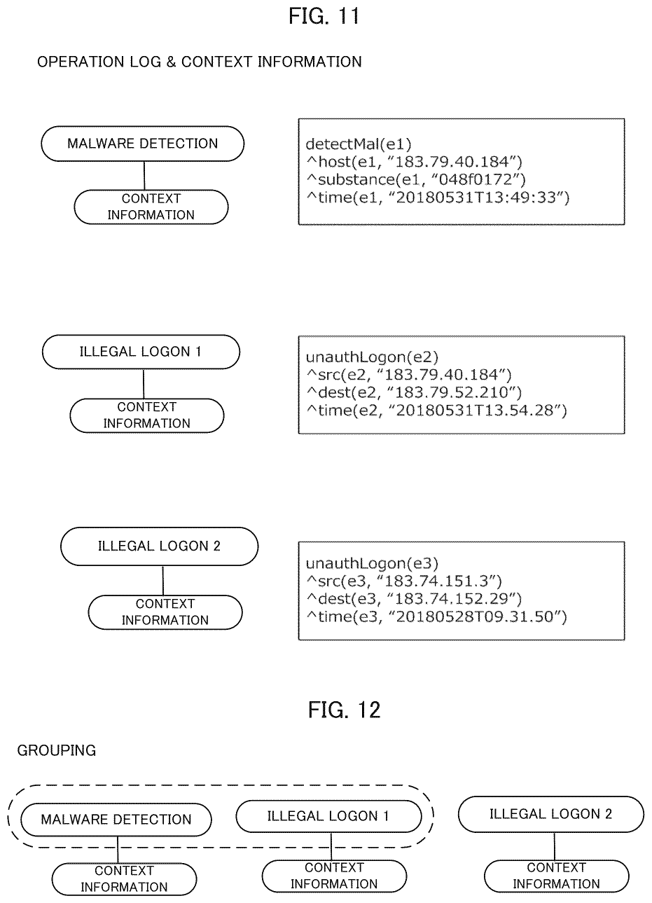

Next, a specific example of the operation of the action plan estimation device 40 will be described with reference to FIGS. 11 to 14. The description of the specific example is performed along each step shown in FIG. 10 described above.

(Step A1)

The information acquisition unit 41 acquires the operation logs shown in FIG. 11 and the accompanying context information. FIG. 11 is a diagram illustrating examples of the operation logs and the context information acquired in step A1 of FIG. 10. In the example of FIG. 10, as the operation logs, “Malware Detection,” “Illegal Logon 1,” and “Illegal Logon 2” are acquired. In FIG. 11, the operation logs and the context information are schematically shown on the left, and their logical expressions are shown on the right.

(Step A2)

As shown in FIG. 12, the group generation unit 42 divides the operation logs acquired in step A1 into groups based on similarity between the context information. FIG. 12 is a diagram illustrating examples of groups generated in step A2 of FIG. 10. As illustrated in FIG. 11, the action entity and the execution location are the same in “Malware Detection” and “Illegal Logon 1,”. Therefore, in the example of FIG. 12, these operations belong to the same group.

(Step A3)

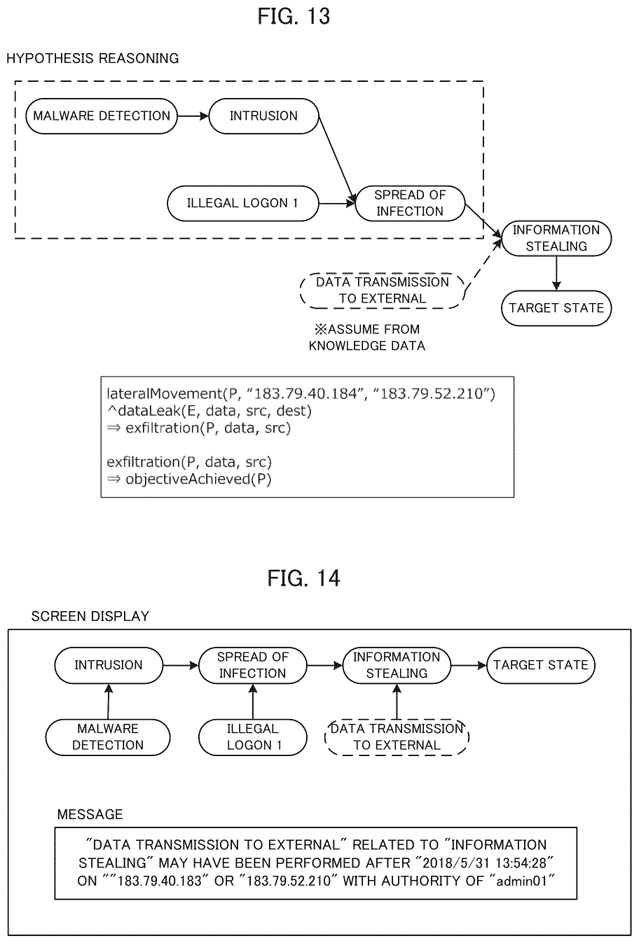

The action plan estimation unit 43 applies the knowledge data to the operation logs included in the groups illustrated in FIG. 12 to perform abductive reasoning. Then, the action plan estimation unit 43 estimates the action plan from the result of the abductive reasoning, as shown in FIG. 13. FIG. 13 is a diagram illustrating an example of the action plan estimated from the abductive reasoning of step A3 in FIG. 10. In the example of FIG. 13, an action performed by the malware is derived from the starting point to the end point “Target State”, wherein the “Malware Detection” and “Illegal Logon 1” included in the group generated in step A2 are used as the starting point. Note that “Data Transmission to External” surrounded by a broken line in FIG. 13 is not an operation acquired as an operation log. However, “Data Transmission to External” is also estimated by the abductive reasoning performed by the action plan estimation unit 43.

(Step A5)

The message creating unit 45 identifies, from among “Actions” included in the abductive reasoning obtained in step A3, those that are not directly connected to the operation logs acquired in step A1. In the example of FIG. 13, “Data Transmission to External” corresponds to it. Subsequently, the message creating unit 45 uses the knowledge data to identify the operation necessary for establishing “Data Transmission to External.” Specifically, the message creating unit 45 identifies “Information Stealing” as an operation necessary for establishing “Data Transmission to External” using the knowledge data.

Next, the message creating unit 45 estimates the context information of “Data Transmission to External” from the context information of the operation log acquired in step A1, e.g., the context information of the “Illegal Logon 1,” which is a necessary condition of “Spread of Infection” immediately before the “Information Stealing” identified as an action required for establishment. Specifically, the message creating unit 45 extracts the execution date and time (time), the action entity (agent), and the execution location (src, dest) respectively in the context information of “Illegal Logon 1” (see FIG. 11).

Next, the message creating unit 45 sets the execution date and time of “Data Transmission to External” after the extracted date and time, and sets the action entity, the action object, and the execution location to the extracted ones. Then, the message creating unit 45 creates a message using “Data Transmission to External”, which is an unconfirmed operation, and the context information set for it. An example of a message is “Data Transmission to External” related to “Information Stealing” may have been performed after “2018/05/31 13:54:28” on “183.79.40.183” or “183.79.52.210” with the authority of “admin01”.

(Step A6)

Next, the action plan output unit 44 outputs the action plan estimated in step A4 and the message generated in step A5 to an external device as shown in FIG. 14. FIG. 14 is a diagram illustrating an example of an action plan and a message displayed on a screen by executing step A6 of FIG. 10. In the example of FIG. 14, the action plan and the message are displayed on the screen.

Note that the above-described action plan estimation device is described in the International Publication WO2020/161780, and its disclosure is incorporated herein by reference.

A part or all of the example embodiments described above may also be described as the following supplementary notes, but not limited thereto.

(Supplementary Note 1)

An inference device comprising:
an observation input means configured to receive an observation as an input;
a hypothesis candidate generation means configured to generate hypothesis candidates by applying inference knowledge to the observation in a backward direction;
a problem conversion means configured to convert the hypothesis candidates to an ILP problem or a SAT problem;
an equivalent problem generation means configured to generate a specified number of equivalent ILP problems or equivalent SAT problems in which an order of variables included in the converted ILP problem or the converted SAT problem is changed;
a solver parallelization means configured to solve the equivalent ILP problems or the equivalent SAT problems by executing the specified number of identical ILP solvers or SAT solvers in parallel; and
an optimal solution output means configured to output a result of the ILP solver or the SAT solver that outputs the result first, among the ILP solvers or the SAT solvers of the specified number, as an optimal solution.

(Supplementary Note 2)

The inference device according to Supplementary note 1,
wherein the converted ILP problem or the converted SAT problem includes constraints, and
wherein the variables include variables defining the constraint.

(Supplementary Note 3)

The inference device according to Supplementary note 2, wherein the equivalent problem generation means changes the order of the constraints, and changes the order of the variables according to the changed order of the constraints.

(Supplementary Note 4)

The inference device according to any one of Supplementary notes 1 to 3, wherein the equivalent problem generation unit generates the equivalent ILP problems or the equivalent SAT problems by changing the order in which the variables are inputted to the ILP solver or the SAT solver.

(Supplementary Note 5)

The inference device according to any one of Supplementary notes 1 to 4, further comprising a solver control unit configured to terminate operation of other ILP solvers or other SAT solvers when one of the specified number of ILP solvers or SAT solvers outputs the result.

(Supplementary Note 6)

An inference method comprising:
receiving an observation as an input;
generating hypothesis candidates by applying inference knowledge to the observation in a backward direction;
converting the hypothesis candidates to an ILP problem or a SAT problem;
generating a specified number of equivalent ILP problems or equivalent SAT problems in which an order of variables included in the converted ILP problem or the converted SAT problem is changed;
solving the equivalent ILP problems or the equivalent SAT problems by executing the specified number of identical ILP solvers or SAT solvers in parallel; and
outputting a result of the ILP solver or the SAT solver that outputs the result first, among the ILP solvers or the SAT solvers of the specified number, as an optimal solution.

(Supplementary Note 7)

A recording medium recording a program, the program causing a computer to execute:
receiving an observation as an input;
generating hypothesis candidates by applying inference knowledge to the observation in a backward direction;
converting the hypothesis candidates to an ILP problem or a SAT problem;
generating a specified number of equivalent ILP problems or equivalent SAT problems in which an order of variables included in the converted ILP problem or the converted SAT problem is changed;
solving the equivalent ILP problems or the equivalent SAT problems by executing the specified number of identical ILP solvers or SAT solvers in parallel; and
outputting a result of the ILP solver or the SAT solver that outputs the result first, among the ILP solvers or the SAT solvers of the specified number, as an optimal solution.

While the present invention has been described with reference to the example embodiments and examples, the present invention is not limited to the above example embodiments and examples. Various changes which can be understood by those skilled in the art within the scope of the present invention can be made in the configuration and details of the present invention.

### DESCRIPTION OF SYMBOLS

12 Processor
20 Knowledge base
21 Observation input unit
22 Hypothesis candidate generation unit
23 ILP/SAT problem conversion unit
24 Equivalent ILP/SAT problem generation unit
25 ILP/SAT solver parallelization unit
26 Parallelized solver control unit
27 Optimal solution output unit
100 Inference device

What is claimed is:

1. An inference device comprising:
a memory configured to store instructions; and
one or more processors configured to execute the instructions to:
receive an observation as an input;
generate hypothesis candidates by applying inference knowledge to the observation in a backward direction;
convert the hypothesis candidates to an ILP problem or a SAT problem;
generate a specified number of equivalent ILP problems or equivalent SAT problems in which an order of variables included in the converted ILP problem or the converted SAT problem is changed;
solve the equivalent ILP problems or the equivalent SAT problems by executing the specified number of identical ILP solvers or SAT solvers in parallel; and
output a result of the ILP solver or the SAT solver that outputs the result first, among the ILP solvers or the SAT solvers of the specified number, as an optimal solution.

2. The inference device according to claim 1,
wherein the converted ILP problem or the converted SAT problem includes constraints, and
wherein the variables include variables defining the constraint.

3. The inference device according to claim 2, wherein the one or more processors change the order of the constraints, and change the order of the variables according to the changed order of the constraints.

4. The inference device according to claim 1, wherein the one or more processors generate the equivalent ILP problems or the equivalent SAT problems by changing the order in which the variables are inputted to the ILP solver or the SAT solver.

5. The inference device according to claim 1, wherein the one or more processors are further configured to execute the instructions to terminate operation of other ILP solvers or other SAT solvers when one of the specified number of ILP solvers or SAT solvers outputs the result.

6. An inference method comprising:
receiving an observation as an input;
generating hypothesis candidates by applying inference knowledge to the observation in a backward direction;
converting the hypothesis candidates to an ILP problem or a SAT problem;
generating a specified number of equivalent ILP problems or equivalent SAT problems in which an order of variables included in the converted ILP problem or the converted SAT problem is changed;
solving the equivalent ILP problems or the equivalent SAT problems by executing the specified number of identical ILP solvers or SAT solvers in parallel; and
outputting a result of the ILP solver or the SAT solver that outputs the result first, among the ILP solvers or the SAT solvers of the specified number, as an optimal solution.

7. A non-transitory computer-readable recording medium recording a program, the program causing a computer to execute:
receiving an observation as an input;
generating hypothesis candidates by applying inference knowledge to the observation in a backward direction;
converting the hypothesis candidates to an ILP problem or a SAT problem;
generating a specified number of equivalent ILP problems or equivalent SAT problems in which an order of variables included in the converted ILP problem or the converted SAT problem is changed;
solving the equivalent ILP problems or the equivalent SAT problems by executing the specified number of identical ILP solvers or SAT solvers in parallel; and
outputting a result of the ILP solver or the SAT solver that outputs the result first, among the ILP solvers or the SAT solvers of the specified number, as an optimal solution.
